(19) United States
(12) Patent Application Publication
(10) Pub. No.: US 2008/0140296 A1
(43) Pub. Date: Jun. 12, 2008

(54) Diesel Engine Control Method

(75) Inventors: Adrien Pillot, Arpajon (FR); Eric Dufay, Itteville (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Boulogne Billancourt (FR)

(21) Appl. No.: 11/908,428

(22) PCT Filed: Feb. 15, 2006
(86) PCT No.: PCT/FR2006/050139

§ 371 Date: Feb. 26, 2008

(30) Foreign Application Priority Data
Mar. 17, 2005 (FR) 0502670

(51) Int. Cl. F02D 41/04; F01N 3/023

(52) U.S. Cl. 701/102; 60/295; 60/285; 701/103

(57) ABSTRACT

The invention relates to a method of controlling a diesel engine that is equipped with a particle filter which is disposed on an exhaust gas line of said engine. The inventive method comprises the following steps, namely: an operation consisting in measuring at least one of the engine operating parameters (P); and a step comprising the regeneration (R) of the particle filter, consisting in passing exhaust gases through the filter at a temperature of between 350° C. and 500° C. The method also includes a step consisting in calculating an engine operating stability criterion (CS), comprising the calculation of at least one derivative over time of the aforementioned parameter(s) (P). According to the invention, when the temperature of the exhaust gases is less than 350° C. and when the calculated engine stability criterion (CS) is included within a predetermined range (B1-B2), the engine is regulated such that the temperature of the exhaust gases is between 350 and 500° C. over a given regeneration time (R).

The present invention relates generally to the field of particle filter regeneration for a diesel engine.

More particularly, the invention relates to a method of controlling a diesel engine fitted with a particle filter placed on a gas exhaust line of said engine comprising:
an operation of measuring at least one of the engine operating parameters (P) from an air flow at the engine intake, a temperature of the exhaust gases entering the particle filter, a temperature of the exhaust gases leaving the particle filter, a temperature of the engine cooling fluid, a speed of the vehicle, of a relative position of depression of an engine accelerator pedal, an engine speed;
a step of regeneration of the particle filter consisting in causing exhaust gases to pass through the particle filter, at a temperature lying between 350° C. and 500° C.

Particle filters are widely used on exhaust lines in order to filter particles contained in the fumes and thus reduce the pollution generated by the diesel engine. The particles filtered by the filter are mainly soot and engine oils. In order to discharge the filter of its particles and thus return optimal filtration thereto and depollution characteristics and reduce the pressure loss induced by the accumulation of particles in the filter, it is a known practice to carry out an operation called filter regeneration.

Conventionally, this regeneration operation is carried out at a temperature higher than 500° C. which is, for example, the case in prior art document EP 1 203 876. The method according to the invention does not relate to this type of regeneration which is carried out at more than 500° C. because they require a considerable injection of energy/various fuels that is harmful to the performance of the engine and because the chemical reactions generated during the regeneration are different from those taking place between 350° C. and 500° C.

The regeneration according to the invention consists in burning the particles contained in the filter by adjusting the temperature of the gases in the filter to between 350° C. and 500° C. The regeneration occurring in this particular temperature range is called passive regeneration as opposed to the other type of regeneration requiring the application of a regeneration catalyst product (high energy-injection fuel).

The filter regeneration method according to the invention therefore relates exclusively to a “passive” regeneration method.

The passive regeneration method causes the conversion of the particles stored in the catalyst (that is to say in the particle filter) into molecules of CO₂. This process occurs continuously in the 350° C. to 500° C. temperature range when the vehicle is running on a motorway and no longer normally occurs outside this temperature range.

The combustion of the soot (carbon) deposited in the particle filter is possible only thanks to the combined effect of an oxidizing element (nitrogen dioxide NO₂) and the temperature.

The passive regeneration chemical reaction is as follows:

C+2NO₂=>CO₂+2NO

It has been noted that certain regenerations are carried out incompletely because the rectional conditions do not allow the oxidation of the soot. In this context, the object of the present invention is to propose an engine control method making it possible to improve the regeneration of the particle filters and reduce the number of incomplete regenerations.

For this purpose, the control method of the invention, furthermore complying with the generic definition given of it by the above preamble, is essentially characterized in that it comprises a step of computing an engine operation stability criterion comprising a computation of at least one derivative over time of at least one of said engine operating parameters and in that, when the temperature of the exhaust gases passing through the particle filter is less than 350° C. and when said computed engine stability criterion lies in a predetermined range, the engine is then regulated so that the temperature of the exhaust gases passing through the particle filter increases and lies between 350 and 500° C. for a given regeneration time.

Thanks to the method according to the invention, the decision is made to increase the temperature of the exhaust gases at least when the computed stability criterion lies in the predetermined range. This stability criterion makes it possible to ensure that the rectional conditions inside the particle filter are in principle stable and in principle are not likely to vary with the risk of producing a partial regeneration.

The invention therefore makes it possible to increase the rate of success of the regenerations by preferably initiating the latter when the operation of the engine is stable. A stable engine operation is an operation ensuring that burnt gases having a temperature lying between 350° C. and 500° C. can circulate in the particle filter at least for the whole time of the planned regeneration.

The inclusion of this stability criterion in the control method in order to allow or not allow the increase of temperature only required for the purpose of regeneration makes it possible to take better account of and anticipate the variations of the operating conditions of the engine and avoid commanding a regeneration that would be carried out incompletely. Accordingly, the performance of the engine is improved, because the quantity of energy used for the regeneration may be reduced relative to a similar engine producing partial and incomplete, hence more frequent, regenerations. Thanks to the invention, it will therefore be necessary to inject less fuel into the engine, to produce a more effective regeneration. On the other hand, the more effective the regeneration, the more capable the filter will be of again storing a considerable quantity of particles, which lengthens the time between two regenerations and increases the service life of the filter.

It is possible, for example, to ensure that the engine regulation adapted so that the temperature of the exhaust gases passing through the particle filter increases and lies between 350 and 500° C. is carried out when the stability criterion lies in the predetermined range and when at least one of the conditions from amongst a condition of weight of soot in the particle filter being greater than a predetermined weight, an engine operating time being greater than a predetermined time, an exhaust gas temperature being greater than a first predetermined temperature, a temperature of the exhaust gases entering the particle filter being greater than a second predetermined temperature, a temperature of the exhaust gases leaving the particle filter being greater than a third predetermined temperature, a temperature of the engine cooling fluid being greater than a fourth predetermined temperature, an air flow at an engine air intake being greater than a predetermined air flow, an engine speed being greater than a predetermined speed, is achieved.

The combination of one condition associated with the stability criterion and another condition associated with the level of a particular engine parameter makes it possible to ensure that the regeneration command is initiated only when it is possible/worthwhile and that it has a chance of success due to the engine stability.

Therefore, the condition of weight of soot in the particle filter being greater than a predetermined weight makes it possible to ensure that the regeneration is actually necessary (for example a regeneration is not ordered if the volume of soot to be oxidized is insufficient).

The engine operating time being greater than a predetermined time is another possible indicator of the degree of particle loading of the filter.

The other conditions that are the temperature of exhaust gases being greater than a first predetermined temperature, the temperature of the exhaust gases entering the particle filter being greater than a second predetermined temperature, the temperature of the exhaust gases leaving the particle filter being greater than a third predetermined temperature and the temperature of the engine cooling fluid being greater than a fourth predetermined temperature, are conditions necessary for evaluating quantities of energy to be injected in order to raise the temperature of the gases in the filter between 350° C. and 500° C. (for a given time).

The condition of air flow, at an air intake of the engine, being greater than a predetermined air flow and the engine speed being greater than a predetermined speed form additional criteria for judging the stability of engine operation.

It is also possible to ensure that the step of computing the stability criterion and the regulation of the engine are managed by a computer connected to sensors.

It is also possible to ensure that the engine operation stability criterion is the derivative of an air flow at an engine air intake and that the engine regulation adapted so that the temperature of the exhaust gases passing through the particle filter increases and lies between 350 and 500° C. is achieved when the stability criterion lies in the predetermined range, this predetermined range being a variable function of at least one of said measured engine operating parameters.

Thanks to this feature, it is possible to dynamically vary the extremes of the range in which the computed criterion must be situated in order to allow the regeneration. This range can therefore be varied according to the current engine operation point, according to a predetermined function and recorded in a memory of an engine control unit. This feature therefore makes it possible to adapt the importance assigned to the stability condition in the method of the invention according to dynamic data measured on the engine.

It is also possible to ensure that the engine regulation, so that the temperature of the exhaust gases passing through the particle filter increases and lies between 350 and 500° C. for a given passive regeneration time, consists in carrying out several injections of fuel into at least one combustion chamber and during one engine cycle.

The invention also relates to a device for applying the method of the invention. This device comprises sensors suitable for measuring at least one of the engine operating parameters and a computer suitable for computing said stability criterion.

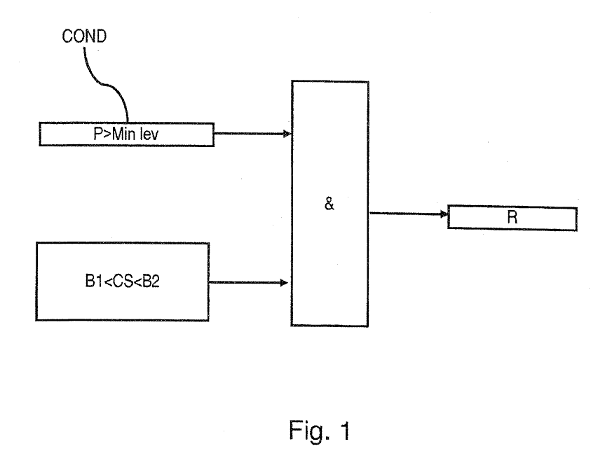

Other features and advantages of the invention will clearly emerge from the description made thereof below, as an indication and in no way limiting, with reference to FIG. 1 appended which represents a logic diagram of the operation of the method according to the invention.

As announced above, the invention relates to a method of controlling a diesel engine fitted with a particle filter placed to filter the particles from the engine exhaust gases.

The method involves permanently and/or periodically measuring engine operating parameters P. The parameters P measured in the method of the invention are usually the same parameters as those normally measured in mass produced vehicles. Accordingly, the method of the invention may be carried out on a large number of mass produced vehicles without having to modify these vehicles beyond changing the programming of the electronic control unit (the unit managing the engine).

The measured parameters P are preferably the air flow at the engine intake, an exhaust gas temperature representative of the temperature of the gases at the particle filter and a relative position of depression of an engine accelerator pedal.

The electronic control unit analyzes:
the position of the pedal in order to evaluate whether the acceleration orders are stable or not;
the air flow in order to determine whether the injection of fuel into the engine is stable or not;
and the temperature of the exhaust gases, on the one hand, in order to evaluate whether the conditions for carrying out the regeneration are achieved or achievable (gas temperature level) and, on the other hand, in order to determine the level of stability of these temperatures (ascertaining whether there is a risk of a sudden temperature drop preventing the complete realization of the passive regeneration).

Other parameters may also be measured in order to calculate the engine operation stability criterion. These other parameters may, for example, be the temperature of the exhaust gases entering the particle filter, the temperature of the exhaust gases leaving the particle filter, the temperature of the engine cooling fluid, the speed of the vehicle, the speed of the engine.

The control unit computes a stability criterion CS that is a function of at least one of the measured parameters P. This parameter used to compute the sensitivity criterion is chosen for being correlated or correlatable with the thermodynamic conditions inside the particle filter. The computation of the stability criterion CS comprises at least the computation of the prime derivative of one of the measured parameters. This parameter P is chosen to be representative of the stability of engine operation.

The stability criterion CS computation may comprise a sum of several prime derivatives as a function of the time of different measured engine parameters P. In this way, the stability criterion CS is representative of the variations of several engine operating parameters P.

Irrespective of the method of computing the engine operation stability criterion, the latter is chosen as being representative of a stability of the thermodynamic conditions inside the particle filter.

If this stability criterion lies within a predetermined range, that is to say that it lies between the predetermined low extreme S1 and high extreme S2, then the stability criterion indicates that the engine has a stable operation.

In this case, the regeneration condition associated with the stability criterion is fulfilled.

FIG. 1 represents an “AND” function having as its first input a logic block “COND” and as second input a second logic block B1<CS<B2.

The first logic block COND defines a condition according to which the parameter P must be greater than a predetermined minimum level “Min lev”.

The second logic block represents the stability condition dependent on the computed stability criterion Cs.

If the outputs of the logic blocks are both at 1, then the output of the “AND” function goes to 1 thereby allowing the application of the passive regeneration step R and the maintenance of the exhaust gas temperature at between 350° C. and 500° C.

In the contrary case, no passive regeneration is allowed.

The first logic condition of FIG. 1 takes account of a single parameter P, but several parameters P may also be taken into account.

Therefore, in a particular embodiment for this first condition “COND” to be fulfilled, it is possible to provide that several parameters measured on the engine must be simultaneously greater than respective minimum levels.

For example, for the condition “COND” to be fulfilled, provision can be made that the weight of soot in the particle filter must be greater than a minimum weight, and that the vehicle has traveled at least a given distance since the last regeneration and that the inlet temperature of the particle filter is greater than a first threshold, and that the temperature of the gases leaving the particle filter is greater than a second threshold and that the temperature of the engine cooling liquid is greater than a third threshold and that the speed of the filtered exhaust gases is greater than a predetermined speed.

In summary, the step of regeneration R of the particle filter consisting in causing the exhaust gases to pass through the particle filter, at a temperature lying between 350° C. and 500° C., is therefore achieved when the stability criterion CS and the condition COND are simultaneously fulfilled. In this case, the engine is then regulated so that the temperature of the exhaust gases passing through the particle filter increases and remains between 350 and 500° C. for a predetermined regeneration time R.

1. A method of controlling a diesel engine fitted with a particle filter placed in a gas exhaust line of said engine comprising:
measuring at least one engine operating parameter (P) selected from air flow at the engine intake, temperature of the exhaust gases entering the particle filter, temperature of the exhaust gases leaving the particle filter, temperature of the engine cooling fluid, speed of the vehicle, the relative position of depression of the engine accelerator pedal, and engine speed; and
a step of regeneration (R) of the particle filter consisting of causing exhaust gases at a temperature between 350° C. and 500° C. to pass through the particle filter, characterized in that it comprises computing an engine operation stability criterion (CS) comprising a computation of at least one derivative over time of at least one of said engine operating parameters (P) and in that, when the temperature of the exhaust gases passing through the particle filter is less than 350° C. and when said computed engine stability criterion (CS) lies in a predetermined range (B1-B2), the engine is then regulated in order that the temperature of the exhaust gases passing through the particle filter increases and lies between 350 and 500° C. for a given regeneration time (R).

2. The method of controlling a diesel engine as claimed in claim 1, characterized in that the engine regulation adapted in order that the temperature of the exhaust gases passing through the particle filter increases and lies between 350 and 500° C. is carried out when the stability criterion (CS) lies in the predetermined range (B1-B2) and when at least one condition (COND) is achieved, said condition being selected from the weight of soot in the particle filter being greater than a predetermined weight, the engine operating time being greater than a predetermined time, the exhaust gas temperature being greater than a first predetermined temperature, the temperature of the exhaust gases entering the particle filter being greater than a second predetermined temperature, the temperature of the exhaust gases leaving the particle filter being greater than a third predetermined temperature, the temperature of the engine cooling fluid being greater than a fourth predetermined temperature, the air flow at an engine air intake being greater than a predetermined air flow, and the engine speed being greater than a predetermined speed.

3. The method as claimed in claim 1, characterized in that the step of computing the stability criterion (CS) and the regulation of the engine are managed by a computer connected to sensors.

4. The method as claimed in claim 1, characterized in that the engine operation stability criterion (CS) is the derivative of air flow at an engine air intake and in that the engine regulation adapted so that the temperature of the exhaust gases passing through the particle filter increases and lies between 350 and 500° C. is achieved when the stability criterion (CS) lies in a predetermined range, said predetermined range being a variable function of at least one of said measured engine operating parameters (P).

5. The method as claimed in claim 1, characterized in that the engine regulation, in order that the temperature of the exhaust gases passing through the particle filter increases and lies between 350 and 500° C. for a given passive regeneration time (R), consists of carrying out several injections of fuel into at least one combustion chamber and during one engine cycle.

6. A device for applying the method as claimed in claim 1, characterized in that it comprises sensors suitable for measuring at least one of the engine operating parameters (P) and a computer suitable for computing said stability criterion (CS).
